(19) United States
(12) Patent Application Publication
(10) Pub. No.: US 2004/0266622 A1
(43) Pub. Date: Dec. 30, 2004

(54) Composition and method for elimination of green and red algae

(76) Inventor: Byung Bae Park, Daejon (KR)

Correspondence Address: Stephen J. Koundakjian, P.O. Box 758, South Pasadena, CA, 91031-0758, US

(21) Appl. No.: 10/807,015

(22) Filed: Mar. 22, 2004

(30) Foreign Application Priority Data
Mar. 31, 2003 (KR) 2003-20232

(51) Int. Cl. A01N 25/00

(52) U.S. Cl. 504/116.1

(57) ABSTRACT

Provided are a green/red algae eliminator, wherein the green/red algae eliminator includes a composite peroxide including at least one selected from a group consisting of metal oxide and metal hydroxide, and metal peroxide, or single metal peroxide, and a method of eliminating the green and red algae by using the green/red algae eliminator, thereby increasing dissolved oxygen, eliminating nutrient sources, and improving a bottom soil property. The green/red algae eliminator may include an agglutinant for agglutinating and precipitating the green and red algae. In addition, the green/red algae eliminator may further include loess. Accordingly, the green/red algae eliminator and the method of eliminating the green and red algae can prevent the fishes from being perished by increasing the dissolved oxygen, without damaging the coast organisms. In addition, it can eliminate phosphorus, a nutrient source of the green and red algae. Furthermore, It can destroy cells of the green and red algae using agglutination and aluminum. It can improve bottom soil and water qualities. Also, the present invention may be effectively applied for a long time.

### BACKGROUND OF THE INVENTION

1. Field of the Invention

The present invention relates to a green/red algae eliminator capable of increasing dissolved oxygen, eliminating nutrient sources, and improving a bottom soil property, and a method of eliminating green and red algae by using the green/red algae eliminator, and more particularly, to a green/red algae eliminator capable of increasing dissolved oxygen, eliminating nutrient sources, and improving a bottom soil property by effectively eliminating green and red algae which have greatly bad effect on environments, thereby minimizing damage caused by the green and red algae.

2. Description of the Related Art

Due to development of a coast and increase of sea contaminants, self-purification power of the coast has reached its limit. Conventional approaches for coping with red-water phenomena occurring at the coast are as follows: evacuation of cages from a fish farm, loess spraying, urgent shipment of fishes, and so on. The amount of damage from the red water phenomenon may be tens of billion won every year.

In addition, since various contaminants are flowing into rivers and lakes, green-water phenomena occur. A large number of green algae induce many problems: clogging of filters in water filtration plants, exhaustion of dissolved oxygen, and suffocation of fishes and shellfishes to death.

Conventional methods of disposing the red-water phenomena occurring at coasts include a method of using microbe as a natural enemy, an electrolysis method, an ultrasonic and ozone treatment method, a scooping method, and a precipitation method. In addition, conventional methods of disposing the green-water phenomena occurring at rivers and lakes include a deep-layer explosion method, a copper sulfate spraying method, a bottom soil dredging method, and a filtration method.

However, these treatments have many problems in that they may be harmful, transitory, expensive, inefficient, and difficult. Therefore, these treatments have not widely used. The most widely used method is the loess spaying method.

The loess spaying method is to absorb and precipitate the green and red algae and destroy the green and red algae with aluminum contained in the loess.

However, since the effect of the loess spraying method is also transitory, it is not possible to eliminate the green and red algae for a long time. Unfortunately, a large amount of sprayed loess may contaminate the environment of bottom soil of sea, rivers, or lakes. Moreover, mucilage including loess particles may be created so that the bottom soil can be acidified. As a result, living things in water may be diseased to death.

For these reason, a green/red algae eliminator that is inexpensive, easily-applicable, long-term effective, environment-protective, and acidification-preventive, and a method of eliminating the green/red algae eliminator.

### SUMMARY OF THE INVENTION

The present invention is directed to a green/red algae eliminator capable of being effective for a long time, increasing dissolved oxygen, eliminating nutrient sources, destroying green and red algae, preventing acidification of bottom soil, and being implemented to inexpensive, easily-applicable, and environment-protective.

The present invention is also directed to a method of eliminating green and red algae by using the green/red algae eliminator.

An aspect of the present invention provides a green/red algae eliminator, wherein the green/red algae eliminator comprises a composite peroxide including at least one selected from a group consisting of metal oxide and metal hydroxide, and metal peroxide, or single metal peroxide, and a method of eliminating the green and red algae by using the green/red algae eliminator, thereby increasing dissolved oxygen, eliminating nutrient sources, and improving a bottom soil property.

The green/red algae eliminator according to the present invention may comprise preferably an agglutinant for agglutinating and precipitating the green and red algae, and more preferably, loess.

Now, the green/red algae eliminator capable of increasing dissolved oxygen, eliminating nutrient sources, and improving a bottom soil property according to the present invention and the method of eliminating the green and red algae will be described in detail.

A green/red algae eliminator capable of increasing dissolved oxygen, eliminating nutrient sources, and improving a bottom soil property according to the present invention may comprises a composite peroxide. In addition, the green/red algae eliminator according to the present invention may comprise the composite peroxide and an agglutinant in a predetermined mixing ratio. In addition, the green/red algae eliminator according to the present invention may comprise the composite peroxide, an agglutinant, and loess in a predetermined mixing ratio. In addition, the green/red algae eliminator not including the loess may be input together with the loess. According to the green/red algae eliminator, it is possible to increase dissolved oxygen, eliminate nutrient sources, and prevent acidification of bottom soil.

Preferably, in the mixing ratio of the green/red algae eliminator comprising the composite peroxide and the agglutinant, the composite peroxide is in a range of 60 to 90 wt % and the agglutinant is in a range of 10 to 40 wt %.

In a case where the peroxide is below 60 wt %, that is, the case where the agglutinant is above 40 wt %, the later-described functions of the peroxide, for example, increase of dissolved oxygen, are lowered. Moreover, the composite of the peroxide and certain agglutinate, for example, aluminum sulfate, may lower pH and induce acidification. On the contrary, in a case where the peroxide is above 90 wt %, that is, the case where the agglutinant is below 10 wt %, the later-described functions of the agglutinant, for example, agglutination and precipitation of green and red algae and pH adjustment are lowered. Preferably, in the mixing ratio of the green/red algae eliminator comprising the composite peroxide, the agglutinant and the loess, the composite peroxide is in a range of 30 to 50 wt %, the agglutinant is in a range of 5 to 20 wt %, and the loess is in a range of 30 to 50 wt %.

In a case where the peroxide is below 30 wt %, that is, the case where the agglutinant and the loess are above 70 wt %, the functions of the peroxide, for example, increase of dissolved oxygen, prevention of acidification, improvement of a bottom soil property are lowered. On the contrary, in a case where the peroxide is above 50 wt %, that is, the case where the agglutinant and the loess are below 50 wt %, the functions of the agglutinant and the loess are lowered.

In a case where the agglutinant is below 5 wt %, that is, the case where the peroxide and the loess are above 95 wt %, the functions of the agglutinant, for example, agglutination and precipitation of the green and red algae and pH adjustment are lowered. On the contrary, in a case where the agglutinant is below 20 wt %, that is, the case where the peroxide and the loess are above 80 wt %, acidification is induced.

In a case where the loess is below 30 wt %, that is, the case where the peroxide and the agglutinant are above 70 wt %, the later-described functions of the loess cannot appear. In a case where the loess is below 50 wt %, that is, the case where the peroxide and the agglutinant are above 50 wt %, the functions of agglutination and increase of dissolved oxygen cannot appear.

The green/red algae eliminator according to the present invention necessarily comprises a composite peroxide. That is, the green/red algae eliminator may include only a metal peroxide. Otherwise, the green/red algae eliminator includes metal oxide and/or metal hydroxide together with the metal peroxide.

Preferably, metal contained in the metal peroxide, the metal oxide, and the metal hydroxide includes alkali metal, alkali earth metal, silicon and aluminum.

The metal peroxide out of the composite peroxide is produced by a reaction of peroxide and the metal oxide and/or the metal hydroxide. The preferred example of the reaction is as follows.

[Formula 1]

MO+H₂O₂→MO₂+H₂O

M(OH)₂+H₂O₂→MO₂+2H₂O

The metal [M] contained in the metal oxide [MO] and the metal hydroxide [M(OH)₂] includes alkali metal such as lithium (Li), sodium (Na), potassium (K), rubidium (Rb), cesium (Cs), and francium (Fr), alkali earth metal such as beryllium (Be), magnesium (Mg), calcium (Ca), strontium (Sr), barium (Ba), and radium (Ra), and other metal such as silicon (Si) and aluminum (Al). In particular, magnesium (Mg) and calcium (Ca) are most preferable in terms of cost and long-term increase of dissolved oxygen.

The peroxide reacted with the metal oxide and/or the metal peroxide is an oxide having a bonding of —O—O—. Examples of the peroxide include hydrogen peroxide (H₂O₂) and various organic or inorganic acids.

Preferably, an additive is added to the metal peroxide in order to ensure its stability associated with temperature and humidity. Preferred examples of the additive include at least one additive selected from a group consisting of liquid sodium silicate, air, phosphoric acid, carbonic acid and carbon dioxide. Preferably, the additive is in a range of 2 to 10 wt % with respect to 100 wt % of the metal oxide and/or the metal hydroxide.

In a case where the additive is below 2 wt %, it is not possible to ensure stability of the metal peroxide associated with temperature and humidity. In a case where the additive is above 10 wt %, the excessive input of the additive may contaminate the environment.

As a result, the metal peroxide, as a product of the reaction, and the non-reacted method oxide and the non-reacted method hydroxide may be obtained. The metal hydroxide is larger than the metal oxide, which is below 5 wt %.

The composition of the metal peroxide varies depending on manufacturing condition including the reaction condition such as an amount of the hydrogen peroxide. Preferably, the composite peroxide such as the metal peroxide is made as powder when the composite peroxide is used for the green/red algae eliminator.

When the metal peroxide powder is input into water, the following reaction of the metal peroxide power and water is slowly performed to generate oxygen and metal hydroxide.

[Formula 2]

MO₂+H₂O→M(OH)₂+1/20₂

The metal peroxide is dissolve in water for a long time. The oxygen generated from the long-term dissolution of the metal peroxide increases the concentration of dissolved oxygen in water. Since the dissolution of the metal peroxide occur at a level of molecules, the method has a greater effect of increasing dissolved oxygen than the conventional method of providing oxygen bubbles.

In addition, since metal ions, positive ions, dissolved from the metal peroxide reacts with hydroxyl radicals in water to form metal hydroxide, the pH in water increases. In addition, non-reacted metal ions, particularly, calcium and magnesium ions are coupled with phosphorus to form a chemically stable composite. The phosphorus is well known as a nutrient for green and red algae.

Now, precipitation of phosphorus will be described. A chemical precipitation of phosphorus is generally performed by adding multi-valued metal ions to form an insoluble phosphate. For example, there are precipitation of phosphorus using calcium and magnesium and precipitation involved in reaction of phosphoric acid and aluminum. First, in a case where there a large amount of OH⁻ ions, the precipitation of phosphorus using calcium and magnesium, well known as a regular dephosphorization method, is utilized. In the method, calcium or magnesium reacts with phosphorus to precipitate Ca₁₀(PO₄)₆(OH)₂ in form of hydroxyl apatite as shown in the following formula.

[Formula 3]

10Ca⁺²+6(PO⁴)⁻³+2OH⁻ [symbol] Ca₁₀(PO₄)₆(OH)₂

Next, in the precipitation involved in reaction of phosphoric acid and aluminum or the like, aluminum or ferrous ions react with phosphorus originated from addition of later-described agglutinant as shown in the following formula.

[Formula 4]

Al⁺³+Hₙ(PO₄)⁻³⁺ⁿ [symbol] AlPO₄+nH⁺

Fe⁺³+Hₙ(PO₄)⁻³⁺ⁿ [symbol] FePO₄+nH⁺

When the composite peroxide is input to water, it reacts with water to generate oxygen, so that the concentration of dissolved oxygen can increase and the pH can increase. In particular, some metal ions react with phosphorus, so that the nutrient sources can be reduced.

Preferably the agglutinant includes aluminum sulfate [Al₂(SO₄)₃], ferrous sulfate, ferric sulfate, ferrous chloride, ferric chloride, PAC and a polymer agglutinant.

The polymer agglutinant is classified into negative or positive ion agglutinants. Examples of the polymer agglutinant include polyacrylate, sodium polyacrylate, and so on.

Since metal ions the agglutinant reacts with phosphorus in water, the additive agglutinant has a function of preventing nutrient sources for the green/red algae besides the function of agglutination and precipitation of the green/red algae. In addition, the agglutinant has a function of adjusting the pH in water.

In particular, aluminum sulfate has a function of destroying the microbe with its aluminum besides the function of agglutination and precipitation of the green/red algae.

On the other hand, the loess is most inexpensive to dispose the green/red algae. The loess is used to prevent green-water phenomena due to green algae in fresh water of a lake, etc., red-water phenomena due to flagellates in salt water of a sea. In addition, the loess is used to improve a bottom soil property. Aluminum oxide, a main composition of the loess, has a function of absorption. When the loess is sprayed in the sea water, the aluminum oxide dissolved therefrom destroy the green algae by absorbs and agglutinate cells of the green algae. However, since the sprayed loess decrease the pH in the sea water, so that the sea water can be acidified. In the present invention, the aforementioned composite peroxide and/or the additive agglutinant are used in order to compensate for this disadvantage,

A method of eliminating green and red algae according to the present invention comprises a step of spraying only the aforementioned green/red algae eliminator or spraying the eliminator together with the loess. In particular, when the green/red algae eliminator without the loess is used, it is possible to eliminate the green and red algae without damages of coastal living things and to improve a bottom soil property and a water quality.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a graph depicting an elimination rate of Anabaena depending upon a dose of green/red algae eliminator according to one preferred embodiment of the present invention;

FIG. 2 is a graph depicting an elimination rate of cochlodinium depending upon a dose of green/red algae eliminator according to one preferred embodiment of the present invention; and

FIG. 3 is a graph depicting an elimination rate of the red algae depending upon a dose of green/red algae eliminator according to one preferred embodiment of the present invention and the loess.

### DETAILED DESCRIPTION OF THE PREFERRED EMBODIMENT

Reference will now be made in detail to the preferred embodiment of the present invention, an example of which is illustrated in the accompanying drawings.

[Embodiments]

In the embodiments, calcium peroxide and magnesium peroxide are obtained from calcium oxide and magnesium oxide, respectively. Also, the calcium peroxide and magnesium peroxide are obtained from calcium hydroxide and magnesium hydroxide, respectively. In Embodiment 1, dissolved oxygen and pH in water are measured in case of using magnesium peroxide. And dissolved oxygen and pH in water are also measured in case of using magnesium peroxide. And calcium peroxide, and dissolved oxygen also is measured with respect to solubility of magnesium peroxide. In Embodiment 2, stability is measured depending upon whether or not an additive is added. In Embodiment 3, an effect of eliminating phosphorus is measured. In Embodiment 4, an effect of eliminating organism causing green/red-water achieved by the present invention is measured and compared with that achieved by using loess only. In Embodiment 5, physiological phenomena of fishes are measured.

First, a process for obtaining calcium peroxide and magnesium peroxide by using calcium oxide and magnesium oxide will be described.

40.31 gram of magnesium oxide (MgO) and 56.08 gram of calcium oxide (CaO) are input into separate containers containing 100 ml of water, respectively, and are stirred to form slurry. Then, 35, 50 and 70 ml of 35% hydrogen hydroxide are input into the containers for 10 minutes. The stirring speed is 100 rpm. The reaction is performed at a temperature of 40° C. to 100° C. for 2 hours. In addition, 2 gram of liquid sodium silicate is added into the containers. After the reaction, the mixture is filtered, and then is input into a desiccator of 100° C. to create powder of magnesium peroxide and calcium peroxide. Contents of the powder of magnesium peroxide and calcium peroxide increase in proportion to an amount of hydrogen hydroxide. 12, 25 and 38 wt % of magnesium peroxide and 35, 68 and 82 wt % of calcium peroxide are obtained with respective to 100 wt % of composite peroxide, respectively.

Next, calcium peroxide and magnesium peroxide are obtained using calcium hydroxide and magnesium hydroxide.

When 58.31 gram of magnesium hydroxide [Mg(OH)₂] and 56.08 gram of calcium hydroxide [Ca(OH)₂] reacted to each other in the same process described above, contents of the powder of magnesium peroxide and calcium peroxide slightly decrease in comparison with those obtained by the above process. 10, 20 and 33 wt % of magnesium peroxide and 28, 55 and 74 wt % of calcium peroxide are obtained with respective to 100 wt % of composite peroxide, respectively.

[Embodiment 1]

In Embodiment 1, for the case of using magnesium peroxide and the case of using magnesium peroxide and calcium peroxide, an amount of oxygen generated by reacting a predetermined amount of composite powder with a predetermined amount of water measured with a dissolved oxygen meter. And the pH of the water is measured to identify a degree of alkali. A reaction temperature is maintained at 20° C.

First, 0.1, 0.3 and 0.5 gram of powder samples of 33 wt % composite magnesium peroxide are input into the water of 1000 ml, respectively. And then maximum values of dissolved oxygen and variations of pH are measured.

Table 1 represents maximum values of dissolved oxygen and variations of pH.

TABLE 1

| Amount of powder | water | 0.1 g | 0.3 g | 0.5 g |
|---|---|---|---|---|
| Maximum value of dissolved | 6.2 | 7.8 | 8.4 | 9.0 |
| oxygen (mg/L) | | | | |
| PH | 7 | 7.6 | 8.0 | 8.2 |

As can be seen in Table 1, a concentration of dissolved oxygen significantly increases due to oxygen generated by addition of magnesium peroxide. Values of dissolved oxygen are high to a degree that it is approximate to a saturated concentration of dissolved oxygen (9.2 mg/L). The powder has an alkali property in view of pH.

Next, 0.1 gram of the composition of magnesium peroxide (33 wt % of magnesium peroxide in composite peroxide) and calcium peroxide (77 wt % of calcium peroxide in composite peroxide) is input into the water of 1,000 ml. And then, maximum values of dissolved oxygen and variations of pH are measured.

Table 2 represents maximum values of dissolved oxygen and variations of the pH in the case where magnesium peroxide and calcium peroxide are added into the composite powder.

TABLE 2

| | magnesium | calcium |
|---|---|---|
| | peroxide | peroxide |
| eliminator | (33 wt %) | (77 wt %) |
| Maximum dissolved | 7.8 | 8.8 |
| oxygen (mg/L) | | |
| pH | 7.6 | 9.2 |

As can be seen in Table 2, since a content of calcium peroxide is higher than that of magnesium peroxide in the composite peroxide, an amount of dissolved oxygen and pH are high.

Next, in a case where the amount of magnesium peroxide powder is 0.3 gram, concentrations of dissolved oxygen are measured by altering a content of the water.

Table 3 represents a variation of an amount of maximum dissolved oxygen according to the amount of added water, in a case where an amount of magnesium peroxide is constant.

TABLE 3

| | Amount of added water (ml) | | | | | |
|---|---|---|---|---|---|---|
| | 200 | 500 | 1,000 | 1,500 | 2,000 | 3,000 |
| Maximum values of | 8.5 | 8.5 | 8.4 | 8.4 | 8.3 | 8.2 |
| dissolved oxygen | | | | | | |
| (mg/L) | | | | | | |

As can be seen in Table 3, a solubility of magnesium peroxide powder in the water is low. In a case where the amount of powder is 0.3 gram, even though the amount of added water increases up to 3,000 ml, there are powders that are not solved in the water. The amount of the dissolved oxygen is maintained substantially constant. Therefore, it can be understood that the effect of generating the dissolved oxygen can be adjusted with the amount of powder added to the water for a long time.

[Embodiment 2]

In Embodiment 2, stability is measured depending upon whether or not an additive is added.

For a case where 2 g of an additive such as Mg(OH)₂ is added and a case where it is not added, 20 gram of the powder is remained under a condition of a temperature of 80° C. and a humidity of 80%, so as to identify the stability with respect to the temperature and the humidity. After one week, a weight variation of the powder is measured.

As a result, in the case where the additive is added, a weight of the remaining powder is 95% of the original weight thereof. In the case of where the additive is not added, a weight of the remaining powder is 73% of the original weight thereof. Consequently, it can be understood that the input of the additive can increase the stability.

[Embodiment 3]

In Embodiment 3, an effect of eliminating phosphorus is measured.

A solution of 10 ppm phosphoric acid is prepared. And then, 0.1 gram of a mixture of magnesium peroxide (33 wt %), calcium peroxide (77 wt %), and aluminum sulfate are added. After one hour, a concentration variation of phosphorus is measured.

Table 4 represents an effect of eliminating phosphorus according to a mixing ratio of magnesium peroxide, calcium peroxide and aluminum sulfate.

TABLE 4

| | Mixing ratio* | | | | | |
|---|---|---|---|---|---|---|
| | 5:0:0 | 0:5:0 | 5:0:1 | 0:5:1 | 4:0:2 | 0:4:2 |
| Concentration of | 1.8 | 1.6 | 0.7 | 0.64 | 0.42 | 0.40 |
| phosphorus (Co = 10 | | | | | | |
| ppm) | | | | | | |
| Elimination rate (%) | 82% | 84% | 93% | 93.6% | 95.8% | 96% |

*mixing ratio: [MgO₂:CaO₂:Al₂(SO₄)₃]

As can be seen in Table 4, above 90% phosphorous is eliminated in most cases.

[Embodiment 4]

In Embodiment 4, in order to identify an elimination rate of organism causing green/red-water phenomena according to a concentration of green/red algae eliminators in lake water and sea water, Anabaena and Cochlodinium which are representative plankton organism frequently causing the green/red-water phenomena in Korean coast are input into beakers, respectively. Then, the effect achieved by the present invention is measured and compared with that achieved by the conventional method using only loess which is a general eliminator.

Specifically, the green/red algae eliminator of which magnesium peroxide and aluminum sulfate are mixed in a ratio of 4:1 is input in a concentration of 0 g/L to 1 g/L into the beakers each containing lake water and sea water in which populations of Anabaena and Cochlodinium are maintained in an amount of 5,000 cells/ml. After one hour, a population of dead organism is counted.

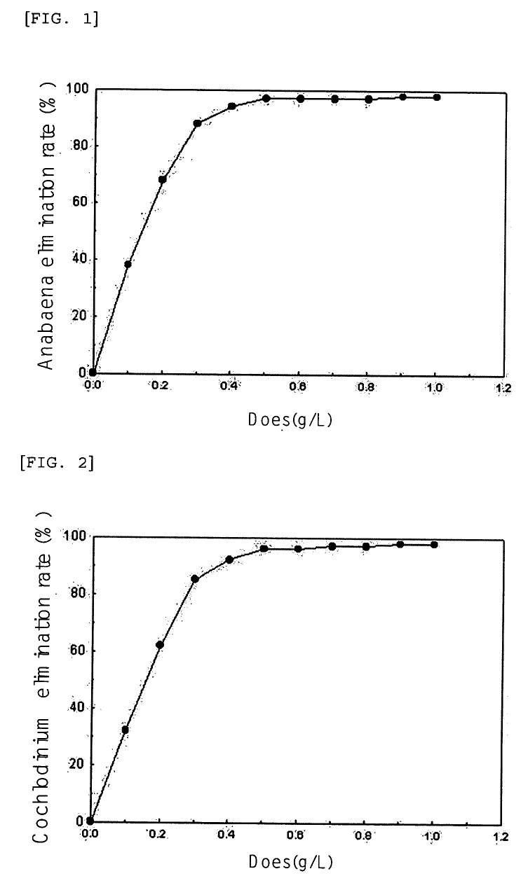

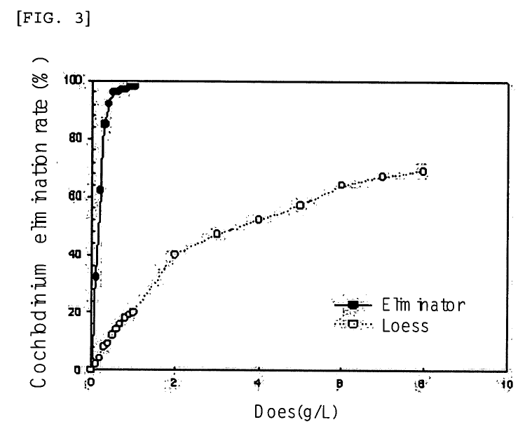

FIG. 1 is a graph depicting an elimination rate of Anabaena depending upon a dose of the green/red algae eliminator manufactured according to one preferred embodiment of the present invention. FIG. 2 is a graph depicting an elimination rate of Cochlodinium depending upon a dose of the green/red algae eliminator according to one preferred embodiment of the present invention.

As shown in FIGS. 1 and 2, Anabaena and Cochlodinium are eliminated at a similar ratio by the green/red algae eliminator manufactured according to one preferred embodiment of the present invention. Further, the elimination rate is very high, that is, above 95%, in a case where the dose thereof is above 0.4 g/L.

Next, the green/red algae eliminator and the loess are input into the beaker in which a population of Anabaena is maintained in an amount of 5,000 cells/ml. In order to compare the effect of eliminating the red algae depending upon the dose thereof, the elimination rate are measured with respect to various input concentrations.

FIG. 3 is a graph depicting elimination rates of the red algae depending upon a dose of the green/red algae eliminator according to one preferred embodiment of the present invention and the loess.

As shown in FIG. 3, in the case of the loess, the elimination rate of above 70% is not obtained even though its dose of above 5 g/L is input. The green/red algae eliminator according to one preferred embodiment of the present invention represents higher elimination rate of above 95% by inputting 10 wt % of the eliminator than the loess.

[Embodiment 5]

In Embodiment 5, in order to test physiological phenomena of fishes due to the green/red algae eliminator according to one preferred embodiment of the present invention, activity and behavior changes of sebastes schlegeli (rockfish) and paralichthys olivaceus (flatfish) are observed for 7 days, in a case where the concentrations of magnesium peroxide, calcium peroxide and aluminum sulfate change.

Table 5 represents results of measuring damages of the fishes according to doses of metallic peroxide and aluminum sulfate.

TABLE 5

| Concentration | | | | |
|---|---|---|---|---|
| of metallic | | | | |
| peroxide | Concentration | | | |
| (magnesium, | of aluminum | Target fishes | | |
| calcium) | sulfate | Rockfish | Flatfish | Remarks |
| 50 ppm | 20 ppm | Normal | Normal | Evaluation |
| 200 ppm | 50 ppm | Normal | Normal | condition: - |
| 500 ppm | 100 ppm | Normal | Normal | individual: |
| 1,000 ppm | 200 ppm | Normal | Normal | fry of 10 cm |
| | | | | adult fish |
| | | | | of 30 cm - |
| | | | | population: |
| | | | | 5 per kind- |
| | | | | period: 7 |
| | | | | days |

As can be seen in Table 5, the target fishes are not influenced by the concentration of the eliminators of the present invention.

With the above description, according to the present invention, a green/red algae eliminator and a method of eliminating the green and red algae can prevent the fishes from being perished by increasing the dissolved oxygen, without damaging the coast organisms. In addition, it can eliminate phosphorus, a nutrient source of the green and red algae. Furthermore, It can destroy cells of the green and red algae using agglutination and aluminum. It can improve bottom soil and water qualities. Also, the present invention may be effectively applied for a long time.

The foregoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A green/red algae eliminator, comprising:
a composite peroxide including at least one selected from a group consisting of metal oxide and metal hydroxide, and metal peroxide, or single metal peroxide;
wherein the metal peroxide is a product of oxidation-reduction reaction involved in composition of at least one selected from the group consisting of metal oxide and metal hydroxide, and metal peroxide.

2. The green/red algae eliminator according to claim 1, further comprising an agglutinant for agglutinating and precipitating the green algae and the red algae.

3. The green/red algae eliminator according to claim 2, further comprising loess.

4. The green/red algae eliminator according to claim 1, wherein metal contained in the metal oxide, the metal hydroxide and the metal peroxide includes alkali metal, alkali earth metal, silicon and aluminum.

5. The green/red algae eliminator according to claim 4, wherein metal contained in the metal oxide, the metal hydroxide and the metal peroxide includes magnesium and calcium.

6. The green/red algae eliminator according to claim 1, wherein the peroxide includes hydrogen hydroxide, organic acid, and inorganic acid.

7. The green/red algae eliminator according to claim 1, wherein the reaction is carried out by adding at least one additive selected from a group consisting of liquid sodium silicate, air, phosphoric acid, carbonic acid and carbon dioxide.

8. The green/red algae eliminator according to claim 7, wherein the additive comprises 2 to 10 wt % of at least one selected from a group consisting of the metal oxide and metal hydroxide.

9. The green/red algae eliminator according to claim 2, wherein the agglutinant is at least one selected from a group consisting of aluminum sulfate, ferrous sulfate, ferric sulfate, ferrous chloride, ferric chloride, PAC and a polymer agglutinant.

10. The green/red algae eliminator according to claim 2, wherein the green/red algae eliminator consists of 60 to 90 wt % of the composite peroxide and 10 to 40 wt % of the agglutinant.

11. The green/red algae eliminator according to claim 3, wherein the green/red algae eliminator consists of 30 to 50 wt % of the composite peroxide, 5 to 20 wt % of the agglutinant, and 30 to 50 wt % of loess.

12. A method for eliminating green and red algae by use of a green/red algae eliminator, wherein the green/red algae eliminator comprises a composite peroxide including at least one selected from a group consisting of metal oxide and metal hydroxide, and metal peroxide, or single metal peroxide, wherein the metal peroxide is a product of oxidation-reduction reaction involved in composition of at least one selected from the group consisting of metal oxide and metal hydroxide, and metal peroxide, the method comprising:
a step of inputting only the green/red algae eliminator or the composition of the green/red algae eliminator and loess to target to be treated.
